(19) United States
(12) Patent Application Publication
(10) Pub. No.: US 2007/0284914 A1
(43) Pub. Date: Dec. 13, 2007

(54) Transverse structural member for a seat area of a vehicle

(75) Inventors: Dieter Schiebel, Korntal-Munchigen (DE); Andrea Lippold, Stuttgart (DE); Wolfgang Neumann, Eberdingen (DE)

Correspondence Address: LERNER GREENBERG STEMER LLP, P O BOX 2480, HOLLYWOOD, FL, 33022-2480, US

(73) Assignee: Dr. Ing. h.c. F. Porsche Aktiengesellschaft

(21) Appl. No.: 11/713,993

(22) Filed: Mar. 5, 2007

(30) Foreign Application Priority Data
Mar. 31, 2006 (DE) 10 2006 014 981.5

(51) Int. Cl. B60N 99/00

(52) U.S. Cl. 296/187.01

(57) ABSTRACT

A transverse structural member for a seat area of a vehicle has a seat transverse center member that has side attaching sections. Two seat transverse side members are each connected to an associated side attaching section of the seat transverse center member and each extends in a transverse direction of the vehicle from the associated side attaching section of the seat transverse center member to form a functional connection in each case with an associated side sill beam section of the vehicle.

### CROSS-REFERENCE TO RELATED APPLICATION

This application claims the priority, under 35 U.S.C. §119, of German application DE 10 2006 014 981.5, filed Mar. 31, 2006; the prior application is herewith incorporated by reference in its entirety.

### BACKGROUND OF THE INVENTION

### Field of the Invention

This invention relates to a transverse structural member for a seat area of a vehicle.

Although it can be used on any vehicles or in any seat areas, this invention, and the problem on which it is based, are explained in more detail by reference to the rear seat area of a passenger car.

Transverse structural members are sufficiently well-known in modern vehicle construction and are formed of arrangements of longitudinal members and transverse members that on the one hand ensure the necessary rigidity and strength of the vehicle body and on the other hand absorb impact energy by the deformation of the individual members in the event of a vehicle impact. Normally, special transverse members are provided in the front areas and also in the rear areas that merely serve to provide a predetermined rigidity of the vehicle body and side collision safety.

It is considerably more difficult to improve side collision safety than front collision safety because there is a comparatively small amount of material between the impacting object and the vehicle occupants and the deformation path available in between is short. Statistics from road traffic accidents show that injuries to occupants during side collisions are increasing both with respect to their frequency and their seriousness, even at relatively low speeds.

Various solutions for improving the side collision protection of passenger cells have already been put forward. These mostly concentrate on reinforcing the doors by fitting reinforcing elements in the form of tubular structures, profiled plates or similar between the outer and inner side panels of the door. These are configured to achieve a rigid structure that when subjected to a specific stress suffer only a certain maximum deformation. In certain cases, reinforcing elements have been provided in the lowest section of the doors, in order to use the floor rail of the passenger cell as a supporting element.

With these approaches, the fact that additional reinforcing components have to be provided, resulting in additional manufacturing effort, additional manufacturing costs and an increase in weight, and are difficult to integrate into the existing structure has proved disadvantageous.

A common further disadvantage of the known door reinforcing configuration is that in the event of a side collision only a small mass of the complete vehicle that comes into contact with another vehicle is available to take the impact energy in the initial stage. The low deformation resistance of the door or of the side part of the vehicle that has taken the collision initially causes only a slight reduction in speed of the impacting vehicle. The occupants therefore suffer contact with the door side moving at high speed and are subject to powerful acceleration relative to their own vehicle during the further deformation.

From German patent DE 42 05 891 C2, a seat supporting structure is known that has seat longitudinal members and seat transverse members. The seat transverse members are connected together via a tunnel transverse member and form an effective combined element in the transverse direction of the vehicle. The ends of the seat transverse members have seat longitudinal members that are spaced apart from the associated door sill beams.

A seat supporting structure of this kind is of course mainly suited to improving the introduction of force into the longitudinal members.

### SUMMARY OF THE INVENTION

It is accordingly an object of the invention to provide a transverse structural member for a seat area of a vehicle that overcomes the above-mentioned disadvantages of the prior art devices of this general type, which offers effective protection against side collisions, especially with respect to the structures already known.

With the foregoing and other objects in view there is provided, in accordance with the invention, a transverse structural member for a seat area of a vehicle having a transverse direction. The transverse structural member contains a seat transverse center member having side attaching sections and two seat transverse side members each being connected to an associated one of the side attaching sections of the seat transverse center member and each extending in the transverse direction of the vehicle from the associated side attaching section of the seat transverse center member to form a functional connection with a respective associated side sill beam section of the vehicle.

The idea on which the invention is based is that the transverse structural member for a seat area has a seat transverse center member that includes side attaching sections, and two seat transverse side members. Each of the seat transverse side members is connectable to an associated side attaching section of the seat transverse center member and each extend in the transverse direction of the vehicle from the associated side attaching section of the seat transverse center member to form an functional connection with a respective associated side sill beam section of the vehicle. In this way, a continuous transverse structural member is created from one side sill beam to the opposite side sill beam.

Compared with the aforementioned approaches, the invention has the advantage that a very rigid transverse structural member is formed in the transverse direction of the vehicle that on the one hand improves the torsional rigidity and on the other hand also absorbs the deformation energy resulting from a side impact and is able to build up the necessary reaction forces. In addition to this function, the structural member serves to accommodate an associated seat well, so that the structural member advantageously performs a dual role.

Furthermore, the transverse structural member according to the invention is disposed at the height of the fenders of the colliding vehicle, so that the fender of the colliding vehicle is prevented from penetrating into the vehicle by the transverse structural member, due to the absorption of the impact energy.

Furthermore, because of the multi-part configuration of the structure, installation is easier and the manufacturing costs and manufacturing processes of the individual parts are optimized because a manufacturing process suitable for each part of the structural member can be chosen. The separately manufactured parts of the structural member are advantageously joined only after manufacture.

According to a preferred development, the seat transverse center member has several reinforcing ribs that preferably run in the longitudinal and transverse directions within the profile. In this way, the rigidity of the seat transverse center member, and therefore of the complete transverse structural member, can be improved and, additionally, side collision safety increased.

According to a further preferred development, the seat transverse center member is connected to both seat transverse side members by a bonded joint and/or a punched-rivet joint. These are reliable methods of joining that are easy to achieve.

According to a further preferred exemplary embodiment, the seat transverse center member has an additional attaching section in each of its two side areas to attach an associated transverse reinforcing element in each case. The transverse reinforcing elements can each be connected to the coupling elements for connecting each of the transverse reinforcing elements to an associated section of the side parts of the vehicle body. This creates an additional, independent load path that in the event of a side collision takes the impact energy of the side part of the vehicle body that has suffered the collision and transmits it via the transverse reinforcing elements and seat transverse center member to the side sill beam section on the opposite side and to the section of the vehicle body on the opposite side. This advantageously increases the overall rigidity and the side-crash safety.

Other features which are considered as characteristic for the invention are set forth in the appended claims.

Although the invention is illustrated and described herein as embodied in a transverse structural member for a seat area of a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a vehicle body with a transverse structural member according to a preferred exemplary embodiment of the invention;

FIG. 2 is a diagrammatic, perspective view of a seat transverse center member according to a preferred exemplary embodiment of the invention;

FIG. 3 is a diagrammatic, perspective view of a closure part according to a preferred exemplary embodiment of the invention;

FIG. 4 is a diagrammatic, perspective view of the seat transverse side member according to a preferred exemplary embodiment of the invention;

FIG. 5 is a diagrammatic, perspective view of the transverse structural member formed of a seat transverse center member and two seat transverse side members according to a preferred exemplary embodiment of the invention;

FIG. 6 is diagrammatic, rear perspective view of the transverse structural member shown in FIG. 5;

FIG. 7 is a diagrammatic, perspective view of a transverse reinforcing element complete with a coupling element according to a preferred exemplary embodiment of the invention; and

FIG. 8 is a diagrammatic, perspective view of the transverse structural member integrated into a vehicle according to a preferred exemplary embodiment of the invention.

### DESCRIPTION OF THE PREFERRED EMBODIMENTS

Unless otherwise stated, the same reference characters in the figures of the drawing refer to components that are the same or have the same function.

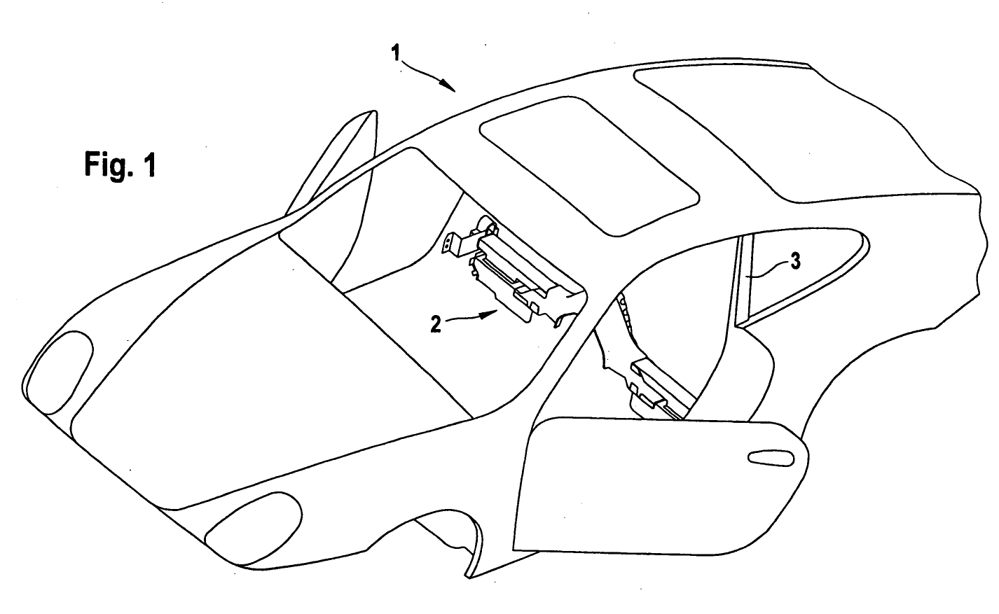

Referring now to the figures of the drawing in detail and first, particularly, to FIG. 1 thereof, there is shown a perspective view of a vehicle body 1 that has a transverse structural member 2 according to a preferred exemplary embodiment of the invention. The transverse structural member 2 is provided approximately at a level of a B-pillar 3 in a transverse direction of a vehicle and serves to take an associated seat well of the rear seat row of the vehicle.

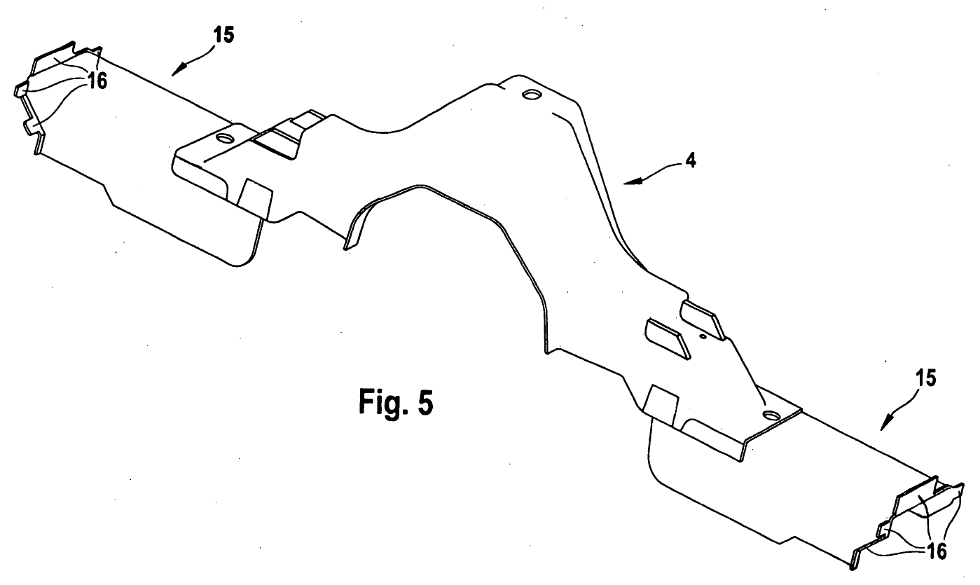

The transverse structural member 2 preferably is formed of three single transverse structural parts, a seat transverse center member 4 and two seat transverse side members 15 disposed on the sides that are described in more detail in the following (see FIG. 5).

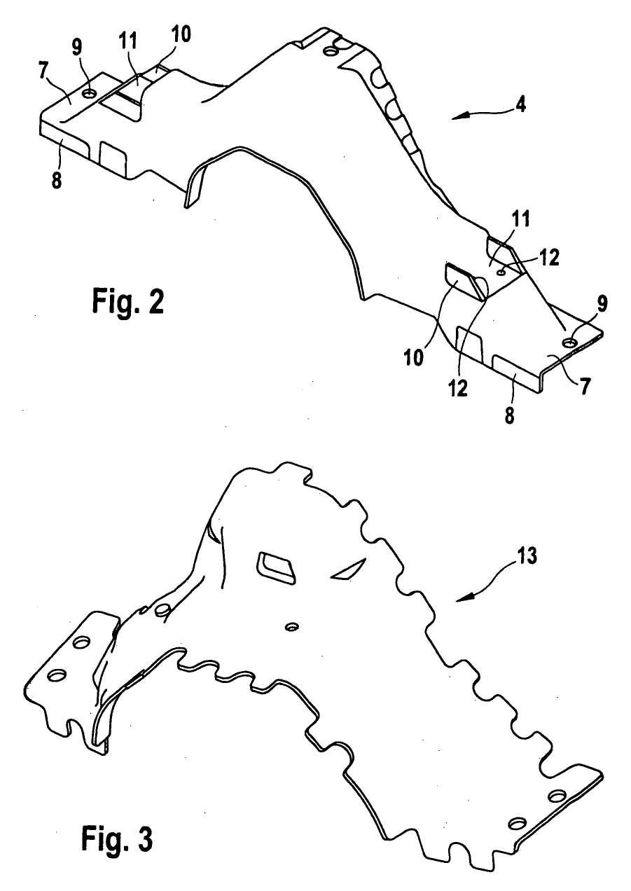

FIG. 2 is a perspective view of the seat transverse center member 4 according to a preferred exemplary embodiment of the invention. According to this exemplary embodiment, the seat transverse center member 4 is configured as a hat-shaped transverse member disposed symmetrically relative to a longitudinal axis of the vehicle. The seat transverse center member 4 preferably has a U-shaped cross-section profile that is open approximately in the direction of the vehicle floor. The seat transverse center member 4 is e.g. manufactured as a casting from a suitable aluminum alloy or similar, so that a transverse structural part with a high transversal rigidity and low weight is guaranteed.

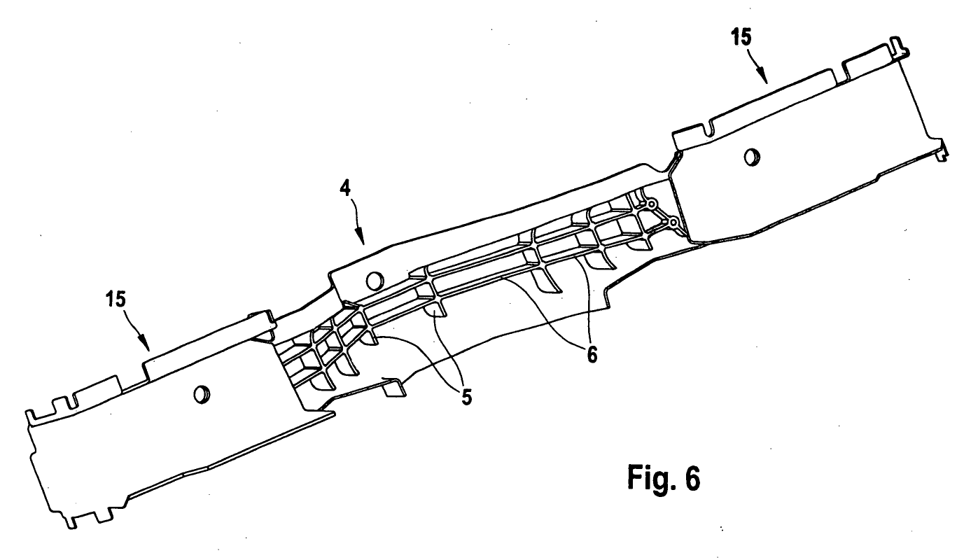

Furthermore, the seat transverse center member 4 is preferably formed with reinforcing ribs 5, 6 on the surface facing the vehicle floor or on the inside of the profile. As can be seen in the view from below in FIG. 6, the reinforcing ribs 5, 6 can be reinforcing ribs 5 that run transversely relative to the longitudinal direction of the seat transverse center member 4, for example, and/or reinforcing ribs 6 running longitudinally. It is, of course, clear to an expert that alternative or additional reinforcing ribs can also be provided in other directions or arrangements. The reinforcing ribs 5, 6 serve to provide additional rigidity to the seat transverse center member 4 and additionally serve to take deformation energy in the event of a side impact.

As can also be seen in FIG. 2, the seat transverse center member 4 has a side attaching section 7 on each of the two sides, each of which serves as an attachment for a seat transverse side member, described further below. For example, each side attaching section 7 has a vertically aligned bearing edge 8 and an attaching hole 9 to take a suitable attaching device for connecting the associated seat transverse side member.

In addition, the seat transverse center member 4 according to the exemplary embodiment has an attaching section 10 on each of the two sides that serves to provide an attachment for additional transverse reinforcing elements, described further below. For example, each attaching section 10 has an attaching area 11 and attaching holes 12 for attaching the respective associated transverse reinforcing elements.

The seat transverse center member 4 also has attaching sections to attach a non-illustrated associated seat well of the rear seat row of the vehicle.

As already explained above, to guarantee adequate stability the seat transverse center member 4 is preferably configured as a casting with a U-shaped cross-section profile open downwards, within which the longitudinal and/or transverse reinforcing ribs 5, 6 are provided. To further increase the rigidity of the transverse structural member in the example, a closure part 13 is provided for closure of the downwards-open side of the U-shaped cross-section profile of the seat transverse center member 4. The closure part 13 is preferably manufactured as a sheet-metal part from a suitable aluminum alloy or similar. The shape of the closure part 13 is preferably complimentary to the shape of the seat transverse center member 4, i.e. also hat-shaped, so that with a suitable mounting of the closure part 13 on the underside of the seat transverse center member 4 a box-shaped transverse member profile with a high transversal rigidity results. The closure part 13 is preferably joined to the seat transverse center member 4 by suitable attaching device, for example punched rivets and/or adhesive.

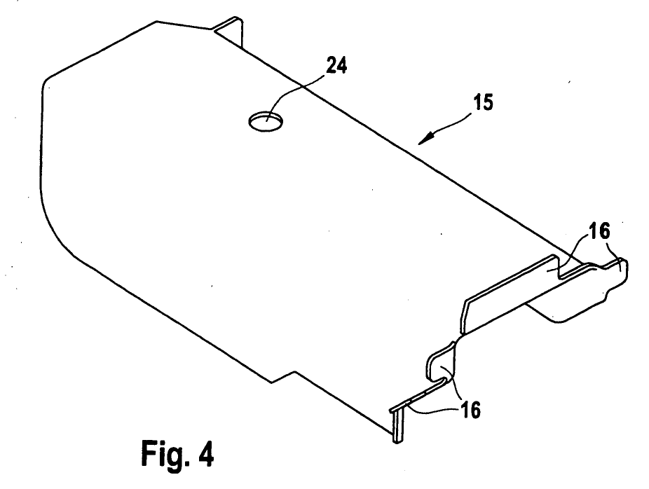

The transverse structural member according to the invention also has two seat transverse members 15, running transversely one on each respective side of the seat transverse center member 4, symmetrically disposed relative to the vehicle longitudinal axis and aligned approximately parallel to the vehicle floor. FIG. 4 illustrates an example of one of the two seat transverse side members 15 according to a preferred exemplary embodiment of this invention.

Both seat transverse side members 15 are preferably formed as sheet-metal molded parts from a suitable aluminum alloy or similar with a U-shaped cross-section profile. The seat transverse side members 15 have geometrical dimensions matched to the side attaching sections 7 of the seat transverse center member 4 in such a way that a flush seating of a section of the seat transverse side member 15 against the corresponding, associated attaching sections 7 of the seat transverse center member 4 is guaranteed. In this way an exact fit of the seat transverse side members 15 on the seat transverse center member 4 can be easily and cheaply accomplished, with an attachment, for example, being by bonding and/or punch riveting. However, other types of attachment, such as bolting, in particular, or similar, are also possible depending on the circumstances.

Each seat transverse side member 15 preferably has angled bearing surfaces 16 on the front face facing towards the outside of the vehicle that directly, or indirectly, for example through an associated flange section of another member or structural part, lie against an associated side sill beam section of the vehicle for support. For example, the sill beam ends of the seat transverse side member 15 bear against a flange section of an associated longitudinal member that in turn bears directly against the associated side sill beam or a side sill reinforcement. Of course, a direct support of the seat transverse side members 15 against the associated side sill beam sections or the sill beam reinforcements is possible.

Consequently, the connection of the seat transverse center member 4 to both seat transverse side members 15 creates a transverse structural member that has a functional direct or indirect connection through the angled bearing surfaces 16 of the seat transverse side members 15 on both sides of the vehicle to each of the associated side sill beam sections. This guarantees a continuous transverse structural member from one side sill beam of the vehicle to the opposite side sill beam that advantageously creates a continuous load path between the two side sill beams to take the deformation energy in the event of a side accident.

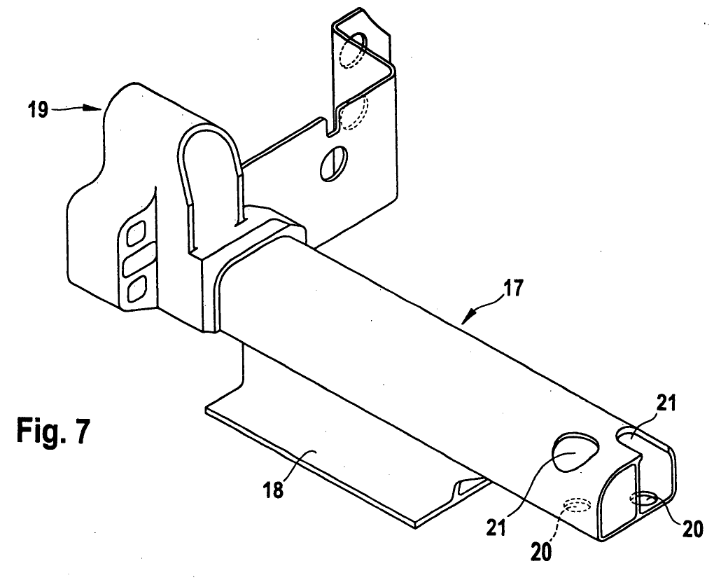

According to a preferred exemplary embodiment of the invention, the transverse structural member additionally has two transverse reinforcing elements 17 that run transversely, also known as Sincap tubes, aligned approximately parallel to the vehicle floor; a perspective view of an example of the transverse reinforcing element 17 being shown in FIG. 7.

The transverse reinforcing elements 17 can be coupled to each other through the associated attaching sections 10 of the seat transverse center member 4, with each extending in the transverse direction of the vehicle from both side areas of the seat transverse center member 4 in the direction of the respective associated inner side part of the vehicle body and approximately parallel to, and above, the respective associated seat transverse side members 15. The transverse reinforcing elements 17 are, for example, each formed as an extruded profile of a suitable aluminum alloy or similar, with each containing one or more, preferably two, hollow chambers. The transverse reinforcing elements 17 each also contain one or more supporting feet 18 as a support on the top of each of the associated seat transverse side members 15.

Furthermore, each transverse reinforcing element 17 can be coupled to a correspondingly associated coupling element 19 that guarantees direct force transmission between the transverse reinforcing elements 17 and the respective associate inner side parts of the vehicle body.

Furthermore, the transverse reinforcing elements 17 have attaching holes 20 that are flush with the attaching holes 12 of the respective attaching sections 10 when the transverse reinforcing elements 17 are fitted to the associated attaching sections 10 of the seat transverse center member 4. A tool opening 21 is, for example, provided above each attaching hole 20 in order, to fit attaching bolts in attaching holes 12 and 20 to bolt the transverse reinforcing elements 17 to the seat transverse center member 4.

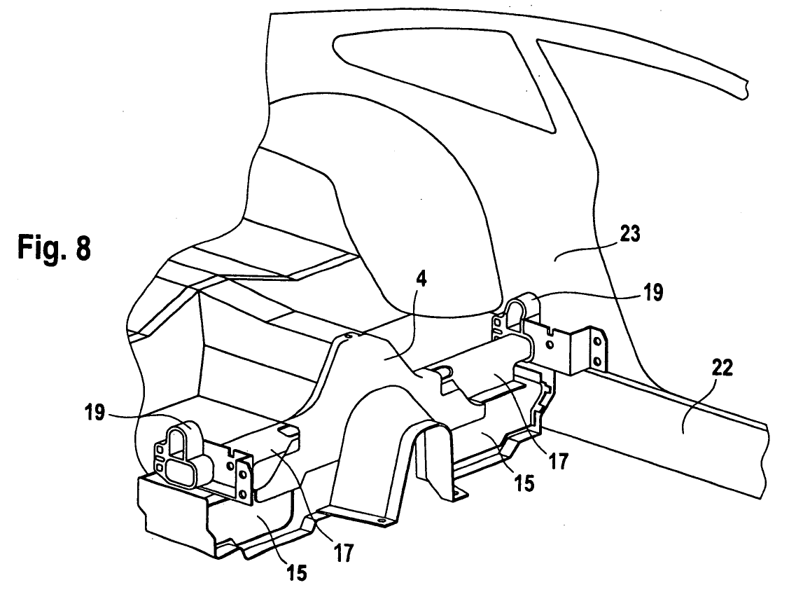

Supporting transverse reinforcing elements 17 at an associated side part of the vehicle body therefore, as shown by a schematic part view in FIG. 8, form an additional independent load path from one side part 23 of the vehicle body to the opposite side part of the body.

A first load path is formed from one side sill beam section 22 of the vehicle through the first seat transverse side member 15, the seat transverse center member 4, the opposite seat transverse side member 15 and the non-illustrated opposite side sill beam section, and a second load path independent of this is formed from one side part 23 of the vehicle body through the coupling element 19, the first transverse reinforcing element 17, the seat transverse center member 4, the opposite transverse reinforcing element 17, the opposite coupling element 19 and the opposite side part of the vehicle. These two independent load paths provide an improved rigidity of the transverse structural member and an improved absorption of the deformation energy in the event of a side impact. The safety of the vehicle occupants can therefore be substantially improved in the event of an accident.

Although this invention has been described mainly using preferred exemplary embodiments, it is not limited to such but instead can be modified in a variety of ways.

We claim:

1. A transverse structural member for a seat area of a vehicle having a transverse direction, the transverse structural member comprising:
a seat transverse center member having side attaching sections; and
two seat transverse side members each being connected to an associated one of said side attaching sections of said seat transverse center member and each extending in the transverse direction of the vehicle from said associated side attaching section of said seat transverse center member to form a functional connection with a respective associated side sill beam section of the vehicle.

2. The transverse structural member according to claim 1, wherein said seat transverse center member and said two seat transverse side members are provided in a symmetrical configuration relative to a vehicle longitudinal axis.

3. The transverse structural member according to claim 1, wherein said seat transverse center member is a hat-shaped transverse member having a U-shaped cross-section profile open approximately in a direction of a vehicle underside.

4. The transverse structural member according to claim 1, wherein said seat transverse center member defines a given profile and several reinforcing ribs disposed on an inside of said given profile.

5. The transverse structural member according to claim 1, wherein said seat transverse center member is a casting.

6. The transverse structural member according to claim 3,
further comprising a closure part; and
wherein said U-shaped cross-section profile of said seat transverse center member has an opening area, said closure part is coupled to said transverse center member in said opening area and forms a closed box profile.

7. The transverse structural member according to claim 6, wherein said closure part is a sheet-metal part formed from a metal alloy.

8. The transverse structural member according to claim 1, wherein said two seat transverse side members are each formed with a U-shaped, cross-section profile.

9. The transverse structural member according to claim 1, wherein said two seat transverse side members are each sheet-metal molded parts formed from a metal alloy.

10. The transverse structural member according to claim 1, wherein said seat transverse center member is connected to said two seat transverse side members through said side attaching sections by at least one of a bonded joint and a punched-rivet joint.

11. The transverse structural member according to claim 1,
further comprising transverse reinforcing elements; and
wherein said seat transverse center member has two side areas and an attaching section in each of said side areas for attaching an associated one of said transverse reinforcing elements to each of said side areas.

12. The transverse structural member according to claim 11, wherein said transverse reinforcing elements are each formed as tubular extruded profiles formed of a metal alloy.

13. The transverse structural member according to claim 11, further comprising connecting elements, said transverse reinforcing elements can each be coupled with said connecting elements for connecting said transverse reinforcing elements to a respective associated section of body side parts of the vehicle.

14. The transverse structural member according to claim 11, wherein said transverse reinforcing elements each have supporting feet for bearing on each of said two seat transverse side members.

15. The transverse structural member according to claim 4, wherein said reinforcing ribs disposed on said inside of said given profile run in at least one of a longitudinal and a transverse direction of said seat transverse center member.

16. The transverse structural member according to claim 5, wherein said seat transverse center member is formed from a metal alloy.

17. The transverse structural member according to claim 5, wherein said seat transverse center member is formed from an aluminum alloy.

18. The transverse structural member according to claim 1, wherein said two seat transverse side members are each sheet-metal molded parts formed from an aluminum alloy.

19. The transverse structural member according to claim 6, wherein said closure part is a sheet-metal part formed from an aluminum alloy.

20. The transverse structural member according to claim 11, wherein said transverse reinforcing elements are each formed as tubular extruded profiles formed of an aluminum alloy.
